(19) United States
(12) Patent Application Publication
(10) Pub. No.: US 2002/0196952 A1
(43) Pub. Date: Dec. 26, 2002

(54) Piezoelectric transceiver

(75) Inventor: Lu-Lee Liao, Taichung (TW)

Correspondence Address: BROWDY AND NEIMARK, P.L.L.C., 624 NINTH STREET, NW, SUITE 300, WASHINGTON, DC, 20001-5303, US

(73) Assignee: Merry Electronics Co., Ltd., Taichung (TW)

(21) Appl. No.: 09/887,349

(22) Filed: Jun. 25, 2001

(51) Int. Cl. H04R 25/00

(52) U.S. Cl. 381/190; 381/152

(57) ABSTRACT

A piezoelectric transceiver comprises a piezoelectric ceramic piece which is provided in two sides with an electrode layer and a bonding wire guided out of the electrode layer. One of the two sides is attached to a vibration piece which is made of a high molecular material having an excellent rigidity as compared with the metal vibration piece of the prior art transceiver. The present invention has a wider volume frequency and a more gentle sound. The present invention is lighter in weight and more energy-efficient.

### FIELD OF THE INVENTION

The present invention relates a transceiver, and more particularly to a piezoelectric transceiver.

### BACKGROUND OF THE INVENTION

A variety of portable electronic products, such as mobile phones, notebook computers, electronic dictionaries, palm-sized game devices, etc., are provided with a loud speaker (receiver) or a microphone (transmitter), which is miniaturized. The dynamic transceiver is commonly used. The piezoelectric transceiver is relatively thin and more energy-efficient. In addition to its simple construction and easy assembly, its production can be automated to lower its production cost.

As shown in FIG. 1, a prior art piezoelectric transceiver 90 comprises a piezoelectric ceramic piece 91 capable of bringing about the piezoelectric effect and provided in two sides thereof with a silver electrode layer 92. A bonding wire 93 is guided from the electrode layer 92 such that the bonding wire 93 is connected with a predetermined connection point of a circuit board (not shown in the drawing). One side of the piezoelectric ceramic piece 91 is attached to one side of a planar metal vibration piece 94. When the piezoelectric piece 91 receives the potential difference (voice signal) from the two bonding wires 93, a mechanical deform is brought about to cause the metal vibration piece 94 to vibrate correspondingly to generate voice. This is the so-called “direct piezoeffect. On the contrary, the so-called “inverse piezoeffect” can convert the voice into the voltage signal.

The prior art piezoelectric transceiver has two shortcomings. In the first place, the vibrational amplitude of the planar metal vibration piece is relatively small, thereby resulting in a relatively poor low frequency effect and a relatively narrow volume frequency. In addition, the metal vibration piece generates a relatively more rigid voice devoid of tenderness. Moreover, the planar vibration piece is not adapted to express the sound characteristics of various products. As a result, the sound performance of the prior art piezoelectric transceiver is not satisfactory. Another drawback of the metal vibration piece is its weight, which is relatively heavier to affect adversely the miniaturization of the piezoelectric transceiver. The prior art piezoelectric transceiver is therefore not power-efficient.

### SUMMARY OF THE INVENTION

The primary objective of the present invention is to provide a piezoelectric transceiver which has a relatively wide volume frequency, and a tender sound, thereby resulting in a better voice-tranmitting performance or a better voice-receiving performance, as well as a wider application scope.

It is another objective of the present invention to provide a piezoelectric transceiver which is light in weight so as to be in line with the current trend of product development.

It is still another objective of the present invention to provide an energy-efficient piezoelectric transceiver which has a relatively high driving efficiency.

The piezoelectric transceiver of the present invention comprises a piezoelectric ceramic piece which is provided in two sides thereof with an electrode layer and a bonding wire connected with the electrode layer. One of the two sides is attached to a vibration piece, which is made of a high molecular material having an excellent rigidity. The piezoelectric transceiver has a relatively wide volume frequency and a relatively tender sound. In light of the vibration piece being light in weight, the piezoelectric transceiver of the present invention is lightweight and energy-efficient.

### BRIEF DESCRIPTION OF THE DRAWINGS

FIG. 1 shows a schematic view of a piezoelectric transceiver of the prior art.

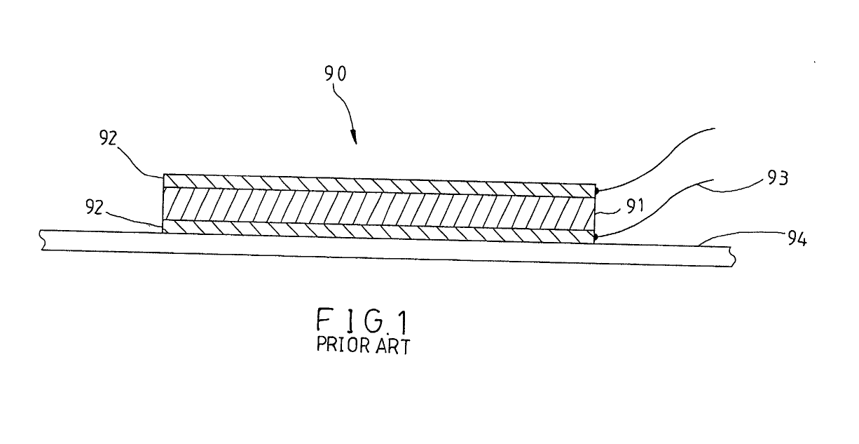

FIG. 2 shows a schematic view of a piezoelectric transceiver of a first preferred embodiment of the present invention.

FIG. 3 shows a schematic view of a piezoelectric transceiver of a second preferred embodiment of the present invention.

FIG. 4 shows a schematic view of a piezoelectric transceiver of a third preferred embodiment of the present invention.

### DETAILED DESCRIPTION OF THE INVENTION

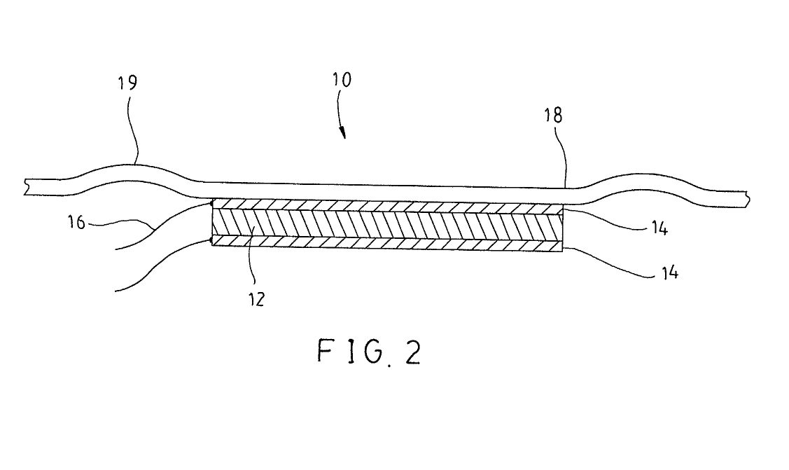

In order to facilitate the labeling and the describing of the present invention, the thickness of the component parts of the present invention is greatly exaggerated in the drawings provided herewith. As shown in FIG. 2, a piezoelectric transceiver 10 of the present invention comprises a piezoelectric ceramic piece 12, which is made of PZT, a titanium compound widely used as a piezoelectric material in the phonographic equipment. The piezoelectric ceramic piece 12 may be also made of Rochelle salt, which is a colorless crystalline compound. The piezoelectric transceiver 10 further comprises two electrode layers 14 of copper. The two electrode layers 14 are fused to the two sides of the piezoelectric ceramic piece 12 by sintering. Two bonding wires 16 are guided out of the two electrode layers 14. A vibration piece 18 is made of a high molecular material having an excellent rigidity. The vibration piece 18 has a round shape. However, the vibration piece 18 is by no means a planar structure and is provided in the periphery with an annular bulged portion 19 protruding outwards (upper portion of the drawing). The piezoelectric ceramic piece 12 is attached at one side (the outer side of the electrode layer 14) to the inner side of the vibration piece 18.

The structure described above is combined with the sound-producing member of an electronic product such that the peripheral edge of the vibration piece 18 is gently fixed on the insulated seat of an application object, and that the two bonding wires 16 are connected with the predetermined connection points of a circuit board for use in the signal input or output. If the transceiver 10 is used as a receiver, the sound signal in the form of potential difference is added to two sides of the piezoelectric ceramic piece 12 via the two bonding wires 16, thereby causing the piezoelectric ceramic piece 12 to deform such that the deform action force causes the vibration piece 18 to vibrate correspondingly to produce sound in agreement with frequency, which is the so-called “direct piezoeffect”. On the contrary, if the transceiver 10 is used as a transmitter, the transceiver 10 converts the sound into piezoelectric signal, which is sent out via the two bonding wires 16. This is due to the inverse piezoeffect.

With regard to the two bonding wires, the present invention makes use of the surface adhesion technique to print on the vibration piece two conductive glues from which the bonding wires are guided out. The piezoelectric ceramic piece is then attached to the vibration piece such that the two electrode layers are connected with the two conductive glues.

The piezoelectric transceiver 10 of the present invention has the following advantages.

According to the laboratory test, the vibration piece 18, which is made of a high molecular material, has a better low frequency effect, and a relatively wide volume frequency. In addition, the vibration piece 18 produces a sound which is more gentle and is relatively low in distortion in the course of the sound transmission. In addition, vibration piece 18 can be easily formed in accordance with the requirement of pattern of the sound feature of the transceiver products. Moreover, the vibration piece 18 of the present invention is relatively light in weight, thereby resulting in an increase in efficiency of driving the vibration piece 18. The piezoelectric transceiver 10 of the present invention is thus more energy-efficient, as compared with the prior art transceiver.

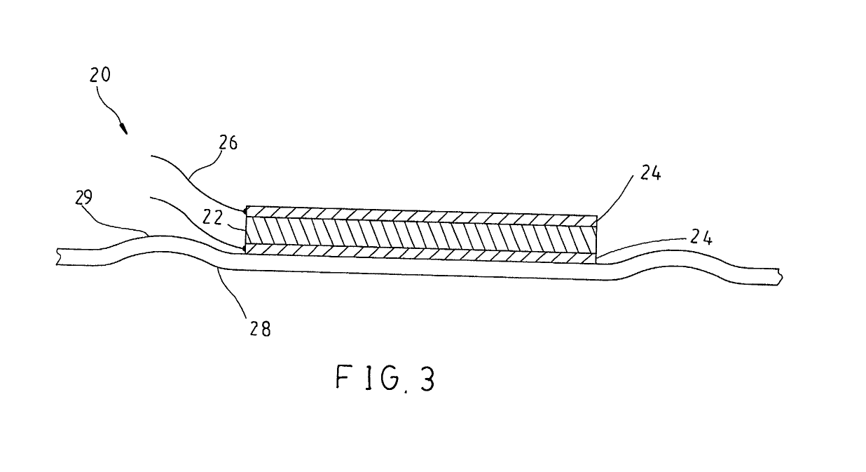

As shown in FIG. 3, the present invention may be modified in pattern and structure in accordance with a specific function. The piezoelectric transceiver 20 of the second preferred embodiment of the present invention comprises a piezoelectric ceramic piece 22 which is provided in two sides thereof with an electrode layer 24 by sintering. A bonding wire 26 is guided out of the electrode layer 24. The piezoelectric ceramic piece is attached to a vibration piece 28 which is made of a high molecular material. The vibration piece 28 is provided with an annular bulged portion 29 protruding in the direction toward one side of the piezoelectric ceramic piece 22.

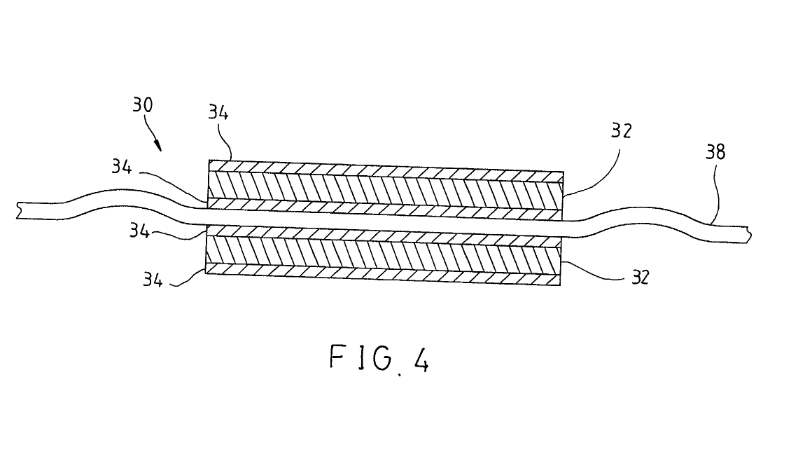

As shown in FIG. 4, a piezoelectric transceiver 30 of the third preferred embodiment of the present invention is characterized by the vibration piece 38 which is provided in two sides thereof with a piezoelectric ceramic piece 32 attached thereto. The piezoelectric ceramic piece 32 is provided in two sides thereof with an electrode layer 34 fused therewith by sintering.

What is claimed is:

1. A piezoelectric transceiver comprising:
a piezoelectric ceramic piece made of a crystalline material capable of bringing about a piezoelectric effect;
two electrode layers made of a conductive material and deposited respectively on two sides of said piezoelectric ceramic piece;
two bonding wires guided out of said two electrode layers; and
a vibration piece attached to the electrode layer of one side of said piezoelectric ceramic piece, said vibration piece being made of a high molecular material having an excellent rigidity.

2. The piezoelectric transceiver as defined in claim 1, wherein said vibration piece is provided with an annular bulged portion protruding in the direction toward said piezoelectric ceramic piece.

3. The piezoelectric transceiver as defined in claim 1, wherein said vibration piece is provided with an annular bulged portion protruding in the direction away from said piezoelectric ceramic piece.

4. The piezoelectric transceiver as defined in claim 1, wherein said vibration piece is further provided with another piezoelectric ceramic piece which is provided in two sides thereof with an electrode layer.
